(19) United States
(12) Patent Application Publication
(10) Pub. No.: US 2023/0081348 A1
(43) Pub. Date: Mar. 16, 2023

(54) COMMUNICATION MODULE AND COMMUNICATION METHOD

(71) Applicant: SONY GROUP CORPORATION, TOKYO (JP)

(72) Inventors: RYUICHI SUZUKI, TOKYO (JP); RYOSUKE MURATA, TOKYO (JP); NOBUO MOTOHASHI, TOKYO (JP); HIROKUNI KAWASAKI, TOKYO (JP)

(21) Appl. No.: 17/799,169

(22) PCT Filed: Feb. 5, 2021
(86) PCT No.: PCT/JP2021/004282

§ 371 Date: Aug. 11, 2022

(30) Foreign Application Priority Data
Feb. 19, 2020 (JP) 2020-026293

(51) Int. Cl. H04B 5/02; H04B 10/116

(52) U.S. Cl. CPC H04B 5/02; H04B 10/116

(57) ABSTRACT

A communication module includes: a transmitter and a receiver each disposed at an approximate center of a connection surface, the transmitter transmitting and the receiver receiving data by a data communication scheme with which the transmitter and the receiver are compatible; and a first electrode and a plurality of second electrodes, the first electrode having a polarity that is different from a polarity of the plurality of second electrodes, the first electrode and the plurality of second electrodes being disposed in an arrangement that is N-fold symmetric (where N is a natural number of 3 or more) in an outer periphery of the transmitter and the receiver, the transmitter and the receiver being disposed on the connection surface.

### TECHNICAL FIELD

The present disclosure relates to a communication module and a communication method.

### BACKGROUND ART

A technique has recently been proposed that configures a robot by combining modules that is able to dynamically change a connectivity with each other (e.g., PTL 1). The robot obtained by combining such modules is able to take various shapes depending on connections between the modules, and is thus able to execute more flexible operation.

Such a robot is able to operate as one robot as a whole by transmitting and receiving data and the like between the combined modules.

### CITATION LIST

### Patent Literature

PTL 1: Japanese Unexamined Patent Application Publication No. 2000-117672

### SUMMARY OF THE INVENTION

It is desired to further increase a degree of freedom of a connection between modules for further increasing a degree of freedom of a shape and movement of a robot configured by combining a plurality of modules.

Accordingly, it is desirable to provide a communication module that is able to further increase a degree of freedom in a connection between communication modules, and a communication method performed by the communication modules.

A communication module according to one embodiment of the present disclosure includes: a transmitter and a receiver each disposed at an approximate center of a connection surface, the transmitter transmitting and the receiver receiving data by a data communication scheme with which the transmitter and the receiver are compatible; and a first electrode and a plurality of second electrodes, the first electrode having a polarity that is different from a polarity of the plurality of second electrodes, the first electrode and the plurality of second electrodes being disposed in an arrangement that is N-fold symmetric (where N is a natural number of 3 or more) in an outer periphery of the transmitter and the receiver, the transmitter and the receiver being disposed on the connection surface.

Further, a communication method according to one embodiment of the present disclosure includes: supplying electric power by a first electrode and a plurality of second electrodes each disposed on a connection surface in an arrangement that is N-fold symmetric (where N is a natural number of 3 or more), the first electrode having a polarity that is different from a polarity of the plurality of second electrodes; and transmitting and receiving data by a transmitter and a receiver each disposed at an approximate center of the connection surface at an inner side than the first electrode and the plurality of second electrodes, by a data communication scheme with which the transmitter and the receiver are compatible.

According to the communication module and the communication method of the embodiment of the present disclosure, it is possible that: the transmitter and the receiver each disposed at the approximate center of the connection surface transmit and receive data by the data communication scheme with which the transmitter and the receiver are compatible; and the first electrode and the plurality of second electrodes disposed in the arrangement that is N-fold symmetric in the outer periphery of the transmitter and the receiver disposed on the connection surface supply the electric power, the first electrode having the polarity that is different from the polarity of the plurality of second electrodes. This makes it possible, for example, for the communication module to cause another communication module to rotate and to be coupled to the connection surface of the communication module.

### BRIEF DESCRIPTION OF DRAWINGS

FIG. 1 is an explanatory diagram illustrating an outline of communication modules according to one embodiment of the present disclosure.

FIG. 2 is a perspective view of a configuration example of connection surfaces of the communication modules according to the embodiment.

FIG. 3 is a schematic cross-sectional view, in a direction perpendicular to the connection surfaces, of each component disposed on one connection surface and each component disposed on another connection surface.

FIG. 4 is a circuit diagram schematically illustrating a circuit configuration in a communication unit.

FIG. 5A is a schematic view of a positional relationship between a transmitter and receivers at a rotation angle of 90 degrees during connection between the communication modules illustrated in FIG. 2.

FIG. 5B is a schematic view of a positional relationship between the transmitter and the receivers at a rotation angle of 180 degrees during connection between the communication modules illustrated in FIG. 2.

FIG. 5C is a schematic view of a positional relationship between the transmitter and the receivers at a rotation angle of 270 degrees during connection between the communication modules illustrated in FIG. 2.

FIG. 6 is a graph illustrating polarity switching cycles of a first electrode and a second electrode.

FIG. 7A is a schematic view of data transmission and reception performed by the communication unit during a CL-Ne period in FIG. 6.

FIG. 7B is a schematic view of data transmission and reception performed by the communication unit during a CL-Po period in FIG. 6.

FIG. 8 is an explanatory diagram illustrating a configuration of a module system including the communication modules according to the present embodiment as a host and clients.

FIG. 9 is a block diagram illustrating a hardware configuration of the host.

FIG. 10 is a block diagram illustrating a hardware configuration of the client.

FIG. 11 is an explanatory diagram illustrating data transmission performed by the client.

FIG. 12 is a block diagram illustrating a function regarding data transmission in an upstream direction or a downstream direction inside the client.

FIG. 13A is a flowchart illustrating a flow of operation of pairing the host with the client.

FIG. 13B is a flowchart illustrating a flow of a process of acknowledging pairing information.

FIG. 14 is an explanatory diagram illustrating an example of connections between the host and the clients and an example of pairing information of each connection.

FIG. 15A is a schematic view of communication path setting performed by the client before the pairing.

FIG. 15B is a schematic view of communication path setting performed by the client after the pairing.

FIG. 16 is a schematic view of a mode of a connection between the host and the client of L1 when the host of L0 assigns an address to the client of L1.

FIG. 17 is a sequence diagram illustrating a flow of operation of the host assigning an address to the client of L1.

FIG. 18 is a schematic view of a mode of a connection between the host and the client when the host assigns an address to the client of L2.

FIG. 19 is a sequence diagram illustrating a flow of operation of the host assigning an address to the client of L2.

FIG. 20 is a block diagram illustrating an example of a connection structure of the host and the clients, and examples of addresses in the connection structure.

### MODES FOR CARRYING OUT THE INVENTION

The following describes embodiments of the present disclosure in detail with reference to the drawings. The following description is a specific example of the present disclosure, but the present disclosure is not limited to the following embodiments. In addition, the present disclosure is not limited to arrangement, dimensions, dimensional ratios, and the like of the constituent elements illustrated in the drawings.

It is to be noted that description is given in the following order.

### 1. Communication Module

1.1. Outline

1.2. Configuration Example

1.3. Operation Example

### 2. System Including Communication Modules

2.1. Overall Configuration Example

2.2. Hardware Configuration Examples of Host and Client

2.3. Data Transmission and Reception Performed by Client

2.4. Operation Examples

### 3. Additional Remarks

### 1. Communication Module

### 1.1. Outline

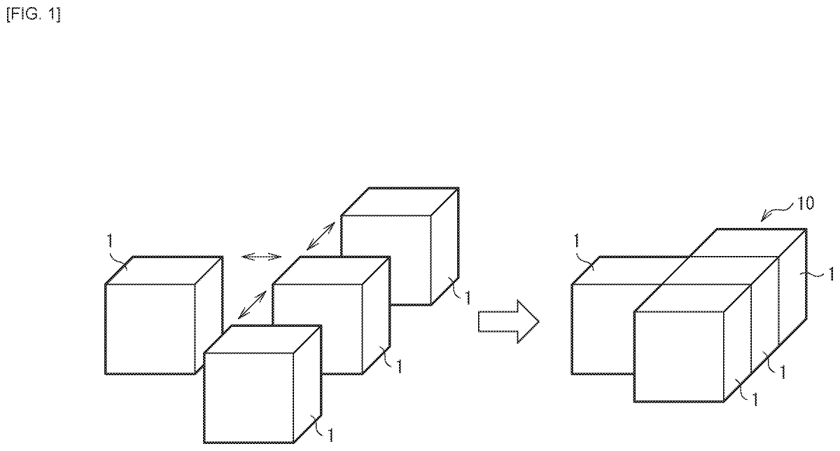

First, referring to FIG. 1, an outline of a communication module according to one embodiment of the present disclosure will be described. FIG. 1 is an explanatory diagram illustrating an outline of communication modules 1 according to the present embodiment.

As illustrated in FIG. 1, a communication module 1 according to the present embodiment is a device that is able to be coupled with another communication module 1, and to transmit and receive data to and from the other communication module 1 via a connection surface. For example, the communication module 1 may have a rectangular parallelepiped shape and may be configured to be coupled to the other communication module 1 on one or more surfaces of the rectangular parallelepiped shape. The communication modules 1 are able to operate as a robot 10 as a whole by transferring data and electric power from and to each other via the respective connection surfaces.

The communication module 1 according to the present embodiment is able to be coupled to the other communication module 1 via the respective connection surfaces at a higher degree of freedom. This allows the communication modules 1 to configure the robot 10 having a more complicated shape. Hereinafter, the communication module 1 according to the present embodiment will be described in detail.

### 1.2. Configuration Example

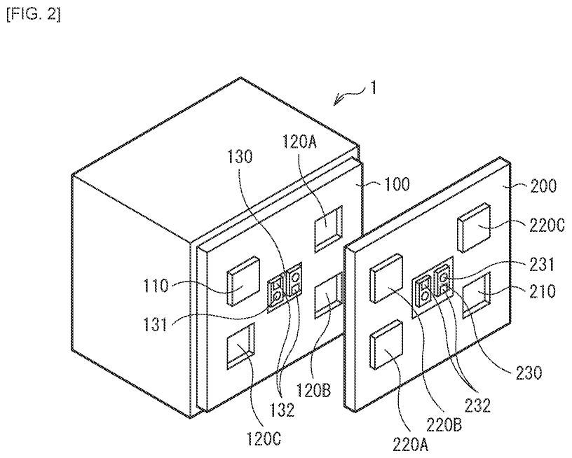

Next, referring to FIG. 2, a configuration of connection surfaces of the communication modules 1 according to the present embodiment. FIG. 2 is a perspective view of a configuration example of connection surfaces of the communication modules 1 according to the embodiment.

As illustrated in FIG. 2, the communication module 1 includes, for example, on a connection surface 100 that is coupled to the other communication module 1: a first electrode 110; a plurality of second electrodes 120A, 120B, and 120C; and a communication unit 130 including a transmitter 131 and a receiver 132. Similarly, the other communication module 1 includes, on a connection surface 200 that is coupled to the communication module 1: a first electrode 210; a plurality of second electrodes 220A, 220B, and 220C; and a communication unit 230 including a transmitter 231 and a receiver 232.

The communication module 1 is coupled to the other communication module 1 in such a manner that: the first electrode 110 is opposed to any one of the second electrode 220A, the second electrode 220B, or the second electrode 220C; and any one of the second electrode 120A, the second electrode 120B, or the second electrode 120C is opposed to the first electrode 210. This allows the communication module 1 to transfer electric power to and from the other communication module 1. Further, the communication module 1 is coupled to the other communication module 1 in such a manner that the communication unit 130 and the communication unit 230 are opposed to each other. This allows the communication module 1 to transmit and receive data to and from the other communication module 1.

It is to be noted that, hereinafter, in a case where the second electrodes 120A, 120B, and 120C are not distinguished from each other, they are collectively referred to as second electrodes 120. Further, in a similar manner, in a case where the second electrodes 220A, 220B, and 220C are not distinguished from each other, they are collectively referred to as second electrodes 220.

The first electrode 110 and the second electrode 120 are electrodes each having a polarity different from each other. The first electrode 110 and the second electrode 120 are electrically coupled in parallel and reversely coupled to the opposing first electrode 210 and second electrode 220, which allows the communication modules 1 to transfer electric power therebetween. Specifically, respective polarities of the first electrode 110 and the second electrode 120 are not fixed to either a plus pole or a minus pole, and are switched at a predetermined cycle. Accordingly, voltage and current supplied from the first electrode 110 and the second electrode 120 are rectified by a rectifier circuit disposed inside the other communication module 1, and are thereafter supplied to a control circuit of the other communication module 1.

It is to be noted that the second electrodes 120A, 120B, and 120C are electrically coupled to each other inside the communication module 1. The first electrode 110 may thus be electrically coupled to any one of the second electrode 220A, the second electrode 220B, or the second electrode 220C. Similarly, the first electrode 210 may be electrically coupled to any one of the second electrode 120A, the second electrode 120B, or the second electrode 120C.

The first electrode 110 and the second electrode 120 may have shapes that engage with each other. For example, the first electrode 110 may be provided as an electrode protruding from the connection surface 100 in a quadrangular shape, and the second electrode 120 may be provided as an electrode recessed from the connection surface 100 in a quadrangular shape corresponding to the first electrode 110. According to this, the first electrode 110 and the second electrode 120 are able to be engaged with each other, and thus be able to transfer electric power more reliably.

The first electrode 110 and the second electrode 120 may further include fixation mechanisms that allow the first electrode 110 and the second electrode 120 to be physically coupled to each other. For example, the first electrode 110 and the second electrode 120 may further include magnets or electromagnets for magnetic coupling, or claws or protrusions for mechanical fixing as the fixation mechanisms. According to this, the first electrode 110 and the second electrode 120 are able couple the connection surface 100 and the connection surface 200 to each other more tightly.

The first electrode 110 and the second electrodes 120 are disposed on the connection surface 100 in such a manner as to be rotationally symmetric to each other in an outer periphery of the communication unit 130. Specifically, the first electrode 110 and the second electrodes 120 are disposed in an arrangement that is N-fold symmetric (where N is a natural number of 3 or more and is a total number of the first electrode 110 and the second electrodes 120) in the outer periphery of the communication unit 130.

In such a case, the communication module 1 is able to be coupled to the other communication module 1 via the connection surface 100 by causing the first electrode 110 and the second electrode 220 to be opposed to each other every time the connection surface 100 rotates at a rotation angle of 360 degrees/N, except for a case where the first electrodes 110 are opposed to each other (a case where the rotation angle is 0 degrees). Thus, it is possible that the communication module 1 is coupled to the other communication module 1 via the connection surface 100 at different rotation angles. The number of rotation angles is determined by subtracting one from of the total number of the first electrode 110 and the second electrodes 120.

For example, in the example illustrated in FIG. 2, one first electrode 110 and three second electrodes 120A, 120B, and 120C that are fourfold symmetric to each other are disposed on the connection surface 100 of the communication module 1. In such a case, the communication module 1 may be coupled to the other communication module 1 via the connection surface 200 which is obtained by rotating the connection surface 100 at an angle of 90 degrees, 180 degrees, or 270 degrees. Specifically, in the connection surface 200 which is obtained by rotating the connection surface 100 at an angle of 90 degrees clockwise, the communication module 1 is coupled to the other communication module 1 in such a manner that the first electrode 110 is opposed to the second electrode 220 at the upper right of the connection surface 200. Further, in the connection surface 200 which is obtained by rotating the connection surface 100 at an angle of 180 degrees clockwise, the communication module 1 is coupled to the other communication module 1 in such a manner that the first electrode 110 is opposed to the second electrode 220 at the lower right of the connection surface 200. Still further, in the connection surface 200 which is obtained by rotating the connection surface 100 at an angle of 270 degrees clockwise, the communication module 1 is coupled to the other communication module 1 in such a manner that the first electrode 110 is opposed to the second electrode 220 at the lower left of the connection surface 200. Thus, the communication module 1 illustrated in FIG. 2 is able to be coupled to the other communication module 1 at three rotation angles, 90 degrees, 180 degrees, and 270 degrees.

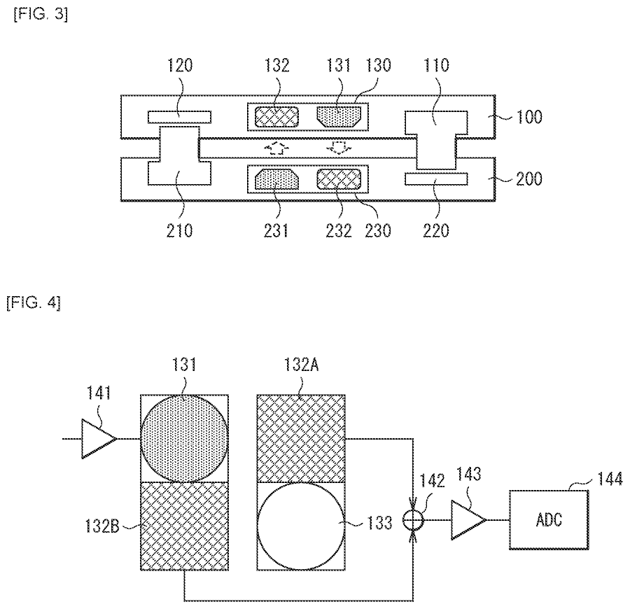

Next, referring to FIG. 3, a more specific configuration of the communication unit 130 will be described. FIG. 3 is a schematic cross-sectional view, in a direction perpendicular to the connection surfaces 100, of each component disposed on the connection surface 100 and each component disposed on the connection surface 200.

As illustrated in FIGS. 2 and 3, the communication unit 130 includes the transmitter 131 and the receiver 132, and transmits and receives data between the communication module 1 and the other communication module 1 by a wireless communication scheme. The communication unit 130 is disposed, for example, at an approximate center of the connection surface 100 at an inner side than the first electrode 110 and the second electrodes 120 in such a manner as to be opposed to the communication unit 230 disposed on the connection surface 200.

The communication unit 130 enables transmission and reception of data by a wireless communication scheme using visible light or infrared light. The communication unit 130 uses the wireless communication scheme instead of a wired communication scheme involving a physical connection, thereby making it possible to smoothly perform transmission and reception of data even if the communication modules 1 are coupled to each other at a rotation angle with a higher degree of freedom. Further, in such a case, the communication unit 130 enables transmission and reception of data even if the connection surface 100 and the connection surface 200 have a gap therebetween.

For example, the transmitter 131 may be a light emitting diode (LED) that emits visible light or infrared light. Further, the receiver 132 may be a photodiode (PD) having a sensitivity to visible light or infrared light. According to this, the transmitter 131 and the receiver 132 enable transmission and reception of data by optical wireless communication. It is to be noted that the transmitter 131 and the receiver 132 may include the light emitting diode and the photodiode provided individually, or may include a photoreflector including the light emitting diode and the photodiode.

It is to be noted that the communication unit 130 may transmit and receive data by a communication scheme other than the above-described communication scheme. For example, the communication unit 130 may transmit and receive data by a wireless communication scheme using a magnetic field using a Hall element. Alternatively, the communication unit 130 may transmit and receive data by a communication scheme using an optical fiber.

Further, the communication unit 130 may alternately perform transmission and reception of data rather than simultaneously. Thus, the communication unit 130 is able to prevent data transmitted by itself and data transmitted from the communication unit 230 opposed thereto from being crossed due to reflection between the connection surface 100 and the connection surface 200.

Specifically, the communication unit 130 supplies each of the transmitter 131 and the receiver 132 with voltage and current to be supplied to the first electrode 110 and the second electrode 120, thereby performing switching between transmission and reception of data to and from the transmitter 131 and the receiver 132 at a cycle synchronized with a cycle of polarity switching of the first electrode 110 and the second electrode 120. In other words, the communication unit 130 is able to alternately turn on and off the transmitter 131 and the receiver 132 by coupling thereto a power source in which polarity switches alternately. Thus, the communication unit 130 is able to perform alternate switching between transmission and reception of data without performing complex control.

Further, the communication unit 130 may include a plurality of receivers 132. In such a case, the communication unit 130 is able to improve reliability of data received by the receiver 132. Further, the communication unit 130 becomes able to determine a rotation angle of the connection between the communication modules 1.

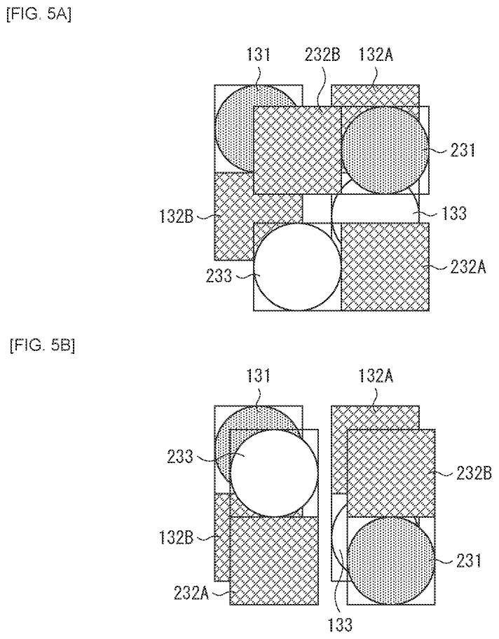

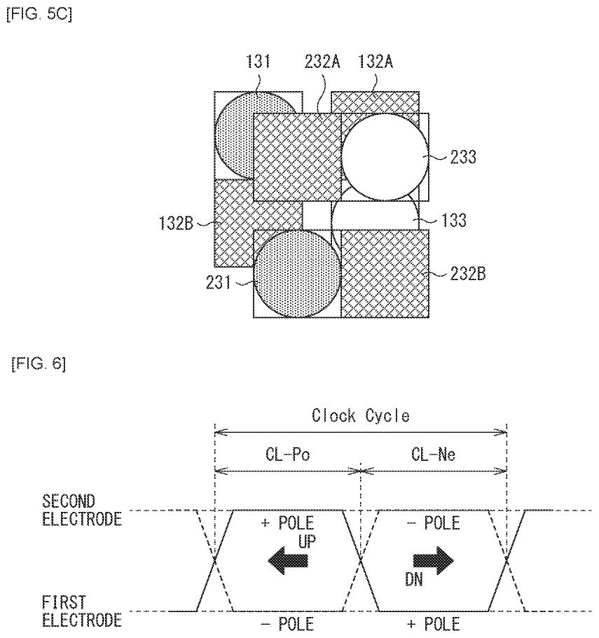

Here, referring to FIGS. 4 to 5C, a method for determining the rotation angle of the connection between the communication module 1 on the basis of a received signal strength will be described. FIG. 4 is a circuit diagram schematically illustrating a circuit configuration in the communication unit 130. FIGS. 5A to 5C are each a schematic view of a positional relationship of the transmitters 131 and 231 versus receivers 132A, 132B, 232A, and 232B at each rotation angle during connection between the communication modules 1 illustrated in FIG. 2.

As illustrated in FIG. 4, for example, two photoreflectors including a light emitting diode and a photodiode are used, thereby using one light emitting diode as the transmitter 131 and using two photodiodes as the receivers 132A and 132B. It is to be noted that the remaining one light emitting diode is used as a dummy transmitter 133 that does not emit light.

Data transmitted from the transmitter 131, after passing through a diode 141 for rectification, is inputted to a light emitting diode included in the transmitter 131, and is transmitted to the other communication module 1 as a light emission signal. In contrast, a light emission signal transmitted from the other communication module 1 is photoelectrically converted by the respective photodiodes included in the receivers 132A and 132B, is thereafter added by an adder 142. The light emission signal that has passed through the adder 142 passes through a diode 143, is thereafter inputted to an analog-to-digital converter 144 (ADC) and converted into a digital signal. According to this, the communication unit 130 is able to receive the light emission signal by each of the receivers 132A and 132B, thus improving reliability of the light emission signal to be received.

Further, the communication unit 130 controls respective reception sensitivities of the receivers 132A and 132B in such a manner as to differ from each other, which makes it possible to determine a rotation angle of the connection between the communication modules 1 on the basis of a reception output of the light emission signal.

Specifically, it is assumed that the reception sensitivity of the receiver 132A is set to 50% and the reception sensitivity of the receiver 132B is set to 100%.

In this case, as illustrated in FIG. 5A, in a case where the communication modules 1 are coupled to each other in a state of being rotated by 90 degrees in the clockwise direction, the receiver 132A is opposed to the transmitter 231, and is therefore able to obtain an output having nearly 100% reception sensitivity. In contrast, the receiver 132B is opposed to a dummy transmitter 233 which does not emit light and is in an oblique positional relationship with the transmitter 231, and is therefore able to obtain an output of slightly more than 10%. Accordingly, in such a case, the output after passing through the analog-to-digital converter 144 is obtained by adding the respective outputs from the receivers 132A and 132B to be 100% to 90%.

Further, as illustrated in FIG. 5B, in a case where the communication modules 1 are coupled to each other in a state of being rotated by 180 degrees in the clockwise direction, the receiver 132A is opposed to the receiver 232B and is in an oblique positional relationship with the transmitter 231, and is therefore able to obtain an output of slightly more than 10%. Similarly, the receiver 132B is opposed to the receiver 232A and is in an oblique positional relationship with the transmitter 231, and is therefore able to obtain an output of slightly more than 10%. Accordingly, in such a case, the output after passing through the analog-to-digital converter 144 is obtained by adding the respective outputs from the receivers 132A and 132B to be 30% to 20%.

Moreover, as illustrated in FIG. 5C, in a case where the communication modules 1 are coupled to each other in a state of being rotated by 270 degrees in the clockwise direction, the receiver 132A is opposed to the dummy transmitter 233 which does not emit light and is in an oblique positional relationship with the transmitter 231, and is therefore able to obtain an output of slightly more than 10%. In contrast, the receiver 132B is opposed to the transmitter 231, and is therefore able to obtain an output having nearly 50% reception sensitivity. Accordingly, in such a case, the output after passing through the analog-to-digital converter 144 is obtained by adding the respective outputs from the receivers 132A and 132B to be 70% to 40%.

As is apparent from the above, the communication module 1 uses multiple receivers 132A and 132B having different reception sensitivities, thereby making it possible to change a magnitude of the output of the received signal in accordance with the rotation angle of the connection between the communication modules 1. Thus, the communication module 1 becomes able to determine the rotation angle of the connection between the communication modules 1 on the basis of the magnitude of the output of the received signal.

It is to be noted that the receivers 132A and 132B may each change the reception sensitivity to 100% after the determination of the rotation angle of the connections between the communication modules 1 is completed. In the communication module 1 according to the present embodiment, the transmitter 131 and the receivers 132A and 132B are each able to handle the signal as a digital H/L signal, for example.

It is to be noted that, although FIGS. 4 to 5C each illustrate the example in which two receivers 132A and 132B are provided, the technology according to the present disclosure is not limited to the above examples. Increasing the number of receivers 132 and causing the respective reception sensitivities of the receivers 132 to be different from each other makes it possible to determine the rotation angle of the connection between the communication modules 1 more finely and with higher accuracy.

In a case where the number of the receivers 132 is greater than or equal to 3 and the total number of the transmitter 131 and the receivers 132 is greater than or equal to 4, the transmitter 131 and the receivers 132 may be disposed on a single circumference of the connection surface 100. In such a case, the transmitter 131 and the receivers 132 on the connection surface 100 and the transmitter 231 and the receivers 232 on the connection surface 200 move on the same circumference even when the communication modules 1 are rotated and coupled to each other. According to this, it is possible to prevent the positional relationship between the transmitter 131 and the receiver 232 or the positional relationship between the receiver 132 and the transmitter 231 from being greatly deviated from the opposing positional relationship.

Further, the communication module 1 is able to determine stability of the connection between the coupled communication modules 1 by monitoring the signal strength received between the transmitter 131 and the receiver 132. Specifically, in a case where the signal strength received between the transmitter 131 and the receiver 132 decreases, the communication module 1 is able to determine that the stability of the connection decreases due to that the communication modules 1 are decoupled or that dirt or the like occurs on the communication unit 130.

### 1.3. Operation Example

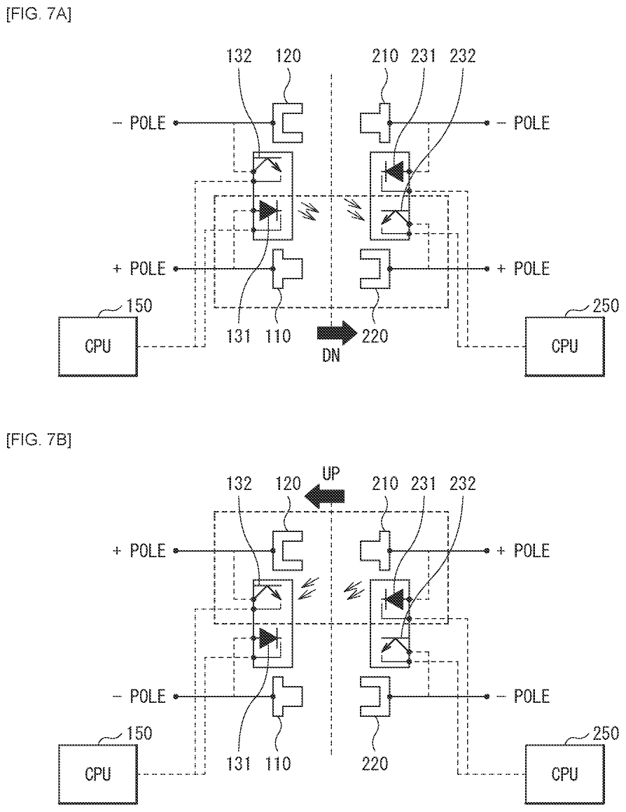

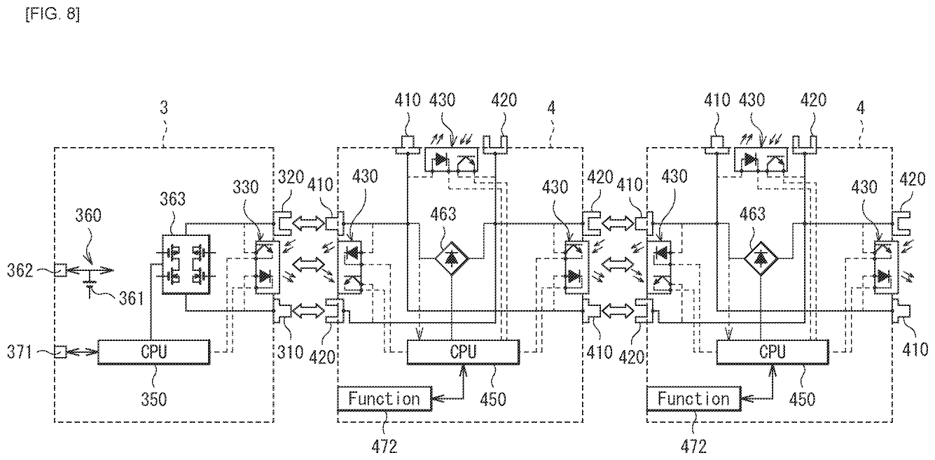

Subsequently, referring to FIGS. 6 to 7B, an operation example of communication between the communication modules 1 will be described. FIG. 6 is a graph illustrating polarity switching cycles of the first electrode 110 and the second electrode 120. FIG. 7A is a schematic view of data transmission and reception performed by the communication unit 130 during a CL-Ne period in FIG. 6. FIG. 7B is a schematic view of data transmission and reception performed by the communication unit 130 during a CL-Po period in FIG. 6.

In FIG. 6, facing the drawing, a line on the upper side indicates a polarity of the second electrode 120, and a line on the lower side indicates a polarity of the first electrode 110. As illustrated in FIG. 6, the polarity of the first electrode 110 and the polarity of the second electrode 120 are switched at a predetermined clock cycle (Clock Cycle).

Specifically, in the CL-Ne period, the first electrode 110 is a plus pole (a “+” pole, a solid line), and the second electrode 120 is a minus pole (a “−” pole, a dotted line). In contrast, in the CL-Po period, the first electrode 110 is the minus pole (the “−” pole, the dotted line), and the second electrode 120 is the plus pole (the “+” pole, the solid line).

In the CL-Ne period, as illustrated in FIG. 7A, the first electrode 110, and the second electrode 220 which is opposed to the first electrode 110 are each the plus pole. As a result, the light emitting diode of the transmitter 131 coupled to the power source on the first electrode 110 side becomes light-emittable, and the photodiode of the receiver 232 coupled to the power source on the second electrode 220 side becomes able to receive the emitted light. At this time, the communication module 1 is able to transmit data from the transmitter 131 to the receiver 232 in a DN-direction by modulating the light emitted by the light emitting diode of the transmitter 131 by a CPU (Central Processing Unit) 150 or performing ON/OFF control in synchronization with the power source.

In contrast, in the CL-Po period, as illustrated in FIG. 7B, the second electrode 120, and the first electrode 210 which is opposed to the second electrode 120 are each the plus pole. As a result, the light emitting diode of the transmitter 231 coupled to the power source on the first electrode 210 side becomes light-emittable, and the photodiode of the receiver 132 coupled to the power source on the second electrode 120 side becomes able to receive the emitted light. At this time, the communication module 1 is able to transmit data from the transmitter 231 to the receiver 132 in an UP-direction by modulating the light emitted by the light emitting diode of the transmitter 231 by a CPU (Central Processing Unit) 250 or performing ON/OFF control in synchronization with the power source.

As described above, the communication module 1 according to the present embodiment is able to switch the communication directions between the coupled communication modules 1 in accordance with the polarity switching of the first electrode 110 and the second electrode 120. According to this, the communication module 1 is able to switch between transmission and reception of the signal in synchronization with the polarity switching of the first electrode 110 and the second electrode 120, thereby preventing a signal to be transmitted and a signal to be received from being crossed

The communication module 1 may, for example, transmit 1-bit data at a single transmission timing and receive 1-bit data at a single reception timing. That is, the communication module 1 may transmit and receive 1-bit data in one cycle of the polarity switching of the first electrode 110 and the second electrode 120. Further, depending on frequencies with which the transmitter 131 and the receiver 132 are compatible, the communication module 1 may transmit data of a plurality of bits at a single transmit timing, and may receive data of a plurality of bits at a single receive timing.

### 2. System Including Communication Modules

### 2.1. Overall Configuration Example

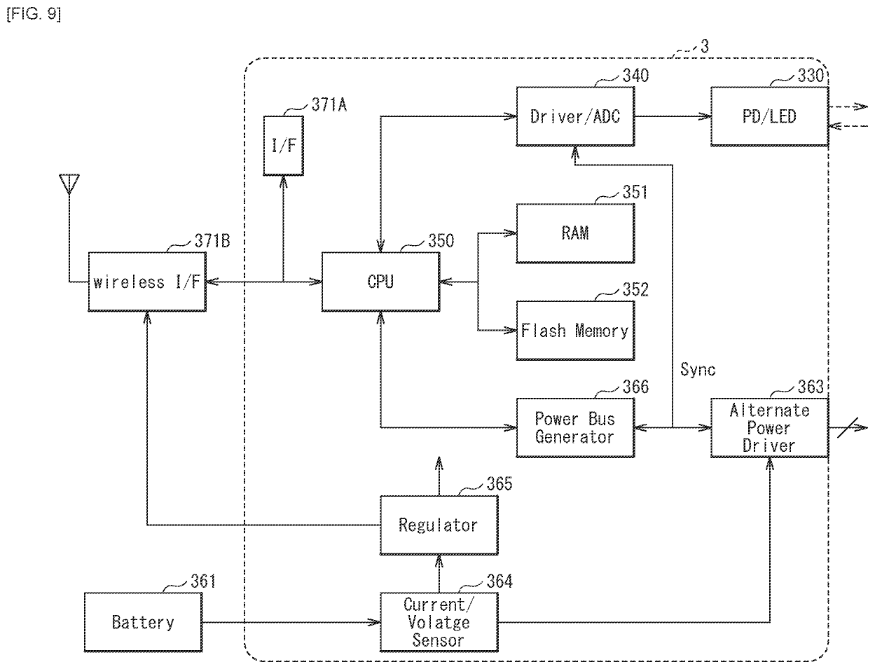

Next, referring to FIG. 8, a module system including the communication modules 1 will be described. FIG. 8 is an explanatory diagram illustrating a configuration of a module system 5 including the communication modules 1 as a host 3 and clients 4.

As illustrated in FIG. 8, the module system 5 is configured by coupling, for example, one host 3 and a plurality of clients 4 to each other. Each of the host 3 and the clients 4 may be configured by the communication module 1 described above. Specifically, the module system 5 is configured in such a manner that the clients 4 are coupled to the host 3 in a tree-shaped structure. In the module system 5, the host 3 sequentially transmits data to the terminal clients 4, thereby executing operation of the module system 5 as a whole.

It is to be noted that, in the following description, in the module system 5 in which the clients 4 are coupled to the host 3 in the tree-shaped structure, a direction in which the host 3 exists is also referred to as an upstream direction, and a direction opposite to the upstream direction is also referred to as a downstream direction.

The host 3 includes, for example, a power source unit 360, a CPU 350, an alternate power driver 363, a communication unit 330, a first electrode 310, and a second electrode 320. Including the power source unit 360 and the CPU 350 makes it possible for the host 3 to operate independently.

The power source unit 360 includes a power source I/F (InterFace) 362 couplable to an external power source, or a battery 361, and operates as a power source of the entire module system 5. The CPU 350 controls the operation of the module system 5 as a whole and, for example, causes the module system 5 to execute an instruction entered through an external I/F 371. The alternate power driver 363 controls the electric power supplied from the power source unit 360 in such a manner that the polarity switches at a predetermined cycle, and supplies the electric power to the first electrode 310 and the second electrode 320. The first electrode 310 and the second electrode 320 are coupled to the first electrode 410 and the second electrode 420, and supply the client 4 with voltage and current whose polarity switches at the predetermined cycle between the first electrode 310 and the second electrode 320. The communication unit 330 includes, for example, a light emitting diode and a photodiode, and switches between emission and reception of the light emission signal in synchronization with the polarity switching cycle of the first electrode 310 and the second electrode 320.

It is to be noted that, similarly with the client 4, the host 3 may be provided with a plurality of connection surfaces each including the first electrode 310, the second electrode 320, and the communication unit 330. In such a case, common voltage and common current are supplied from the alternate power driver 363 to each of the first electrodes 310 and the second electrodes 320 provided on the plurality of connection surfaces. In contrast, to each of the communication units 330 provided on the plurality of connection surfaces, data is individually supplied from the CPU 350.

The client 4 includes a CPU 450, a function unit 472, a power rectifier 463, a communication unit 430, the first electrode 410, and the second electrode 420. The client 4 causes the function unit 472 to operate on the basis of the electric power and the instruction supplied from the host 3.

The CPU 450 controls operation of the function unit 472, for example, on the basis of the instruction from the host 3. Further, the CPU 450 controls transmission and reception of data to and from the client 4 coupled downstream. The function unit 472 is a function block provided for each client 4 and operates in accordance with the instruction from the host 3. The function unit 472 may be, for example, a drive such as a motor or an actuator, a controller such as a servo-circuit, a light-emitting unit such as a light emitting diode, or a sensing unit such as a sensor or a camera. The power rectifier 463 rectifies the voltage and the current supplied through the first electrode 410 and the second electrode 420, and converts the rectified voltage and current into direct-current voltage or direct current. The voltage and the current rectified by the power rectifier 463 are supplied to the CPU 450, a function unit 472, and the like. The first electrode 410 and the second electrode 420 are coupled to the first electrode 310 and the second electrode 320 of the host 3, or to the first electrode 410 and the second electrode 420 of another client 4, and receive or transmit voltage and current whose polarity switches at a predetermined cycle. The communication unit 430 includes, for example, a light emitting diode and a photodiode, and switches between emission and reception of the light emission signal in synchronization with the polarity switching cycle of the first electrode 410 and the second electrode 420.

It is to be noted that the client 4 is provided with a plurality of connection surfaces each including the first electrode 410, the second electrode 420, and the communication unit 430. The voltage and the current supplied from the host 3 are directly supplied to each of the first electrodes 410 and the second electrodes 420 provided on the plurality of connection surfaces. In contrast, to each of the communication units 430 provided on the plurality of connection surfaces, data is individually supplied from the CPU 450.

### 2.2. Hardware Configuration Examples of Host and Client

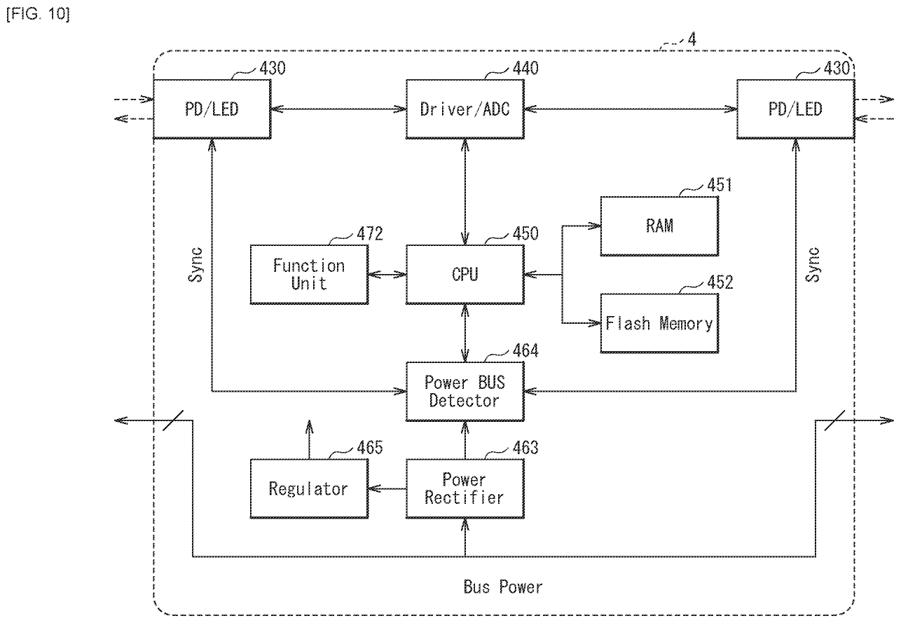

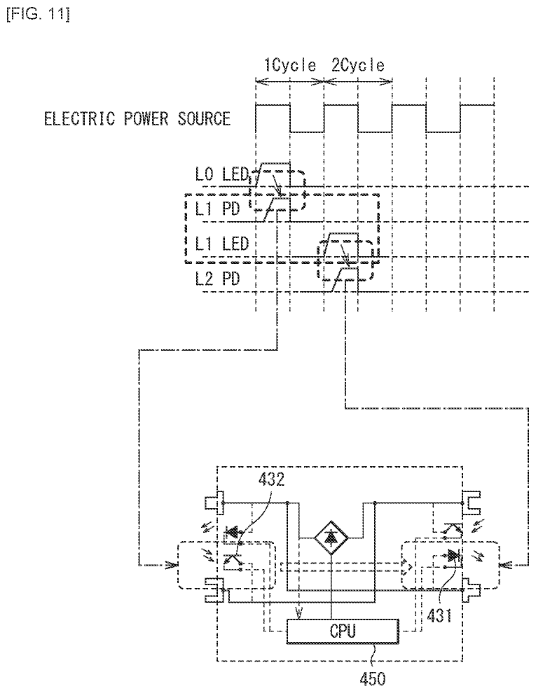

Subsequently, referring to FIGS. 9 and 10, more specific hardware configurations of the host 3 and the client 4 will be described. FIG. 9 is a block diagram illustrating a hardware configuration of the host 3. FIG. 10 is a block diagram illustrating a hardware configuration of the client 4.

As illustrated in FIG. 9, the host 3 includes, for example, the CPU 350, a RAM 351, a flash memory 352, a current/voltage sensor 364, a regulator 365, a power BUS generator 366, the alternate power driver 363, a communication control circuit 340, and the communication unit 330.

The CPU 350 operates as an arithmetic processing unit or a control unit and controls overall operation of the host 3 in accordance with various programs recorded in the RAM 351 or the flash memory 352. The RAM 351 temporarily stores programs executed by the CPU 350 and parameters and the like used in executing the programs. The flash memory 352 is a semiconductor storage device and is a data storage device in the host 3. The flash memory 352 may store programs to be executed by the CPU 350, various kinds of data, or various kinds of data obtained from the outside.

In addition, the CPU 350 is coupled to an interface (I/F) 371A and a wireless interface (wireless I/F) 371B that accept an input from the outside. The CPU 350 may cause the module system 5 to operate on the basis of an instruction entered via the interface 371A and the wireless interface 371B. The interface 371A is, for example, a connection port such as a USB (Universal Serial Bus). The wireless interface 371B is, for example, a wireless communication interface such as Wi-Fi (registered trademark) or Bluetooth (registered trademark).

The current/voltage sensor 364 senses voltage and current of electric power supplied from the battery 361. The regulator 365 is a power source circuit that controls voltage and current supplied to the CPU 350 on the basis of a result obtained by the current/voltage sensor 364. The power BUS generator 366 converts the electric power supplied from the battery 361 into electric power which is suppliable to the power BUS. The alternate power driver 363 controls voltage and current generated by the power BUS generator 366 in such a manner that the polarity switches at a predetermined cycle.

The communication unit (PD/LED) 330 includes, for example, a light emitting diode (LED) as a transmitter, and a photodiode (PD) as a receiver. The communication control circuit (Driver/ADC) 340 is a driving circuit that controls driving of the communication unit 330. The communication control circuit 340 controls the communication unit 330 in such a manner that emission and reception of the light to and from the light emitting diode and the photodiode are switched in synchronization with the switching of the polarity of the power source performed by the alternate power driver 363.

As illustrated in FIG. 10, the client 4 includes the CPU 450, a RAM 451, a flash memory 452, a regulator 465, the power rectifier 463, a power BUS detector 464, the function unit 472, a communication control circuit 440, and the communication unit 430.

The CPU 450 operates as an arithmetic processing unit or a control unit and controls operation of the function unit 472 or the like in accordance with various programs recorded in the RAM 451 or the flash memory 452. The RAM 451 temporarily stores programs executed by the CPU 450 and parameters and the like used in executing the programs. The flash memory 452 is a semiconductor storage device and is a data storage device in the client 4. The flash memory 452 may store programs to be executed by the CPU 450, various kinds of data, or various kinds of data obtained from the outside.

The power rectifier 463 rectifies the voltage and the current supplied from the host 3, and converts the rectified voltage and current into direct-current voltage or direct current. The regulator 365 is a power source circuit that controls voltage and current supplied to the CPU 450 and the function unit 472. The power BUS detector 464 is a detection circuit, and detects synchronization between the polarity switching cycle of the voltage and the current supplied from the host 3 and the light emission and reception cycle of the communication unit 430.

The function unit 472 is a device group provided for each function of the client 4. The function unit 472 may be, for example, a drive such as a motor or an actuator, a controller such as a servo-circuit, a light-emitting unit such as a light emitting diode, or a sensing unit such as a sensor or a camera.

The communication unit (PD/LED) 430 includes, for example, a light emitting diode (LED) as a transmitter, and a photodiode (PD) as a receiver. The communication control circuit (Driver/ADC) 440 is a driving circuit that controls driving of the communication unit (PD/LED) 430. The communication control circuit 440 controls the communication unit 430 in such a manner that emission and reception of the light to and from the light emitting diode and the photodiode are switched in synchronization with the switching of the polarity of the power source supplied from the host 3.

### 2.3. Data Transmission and Reception Performed by Client

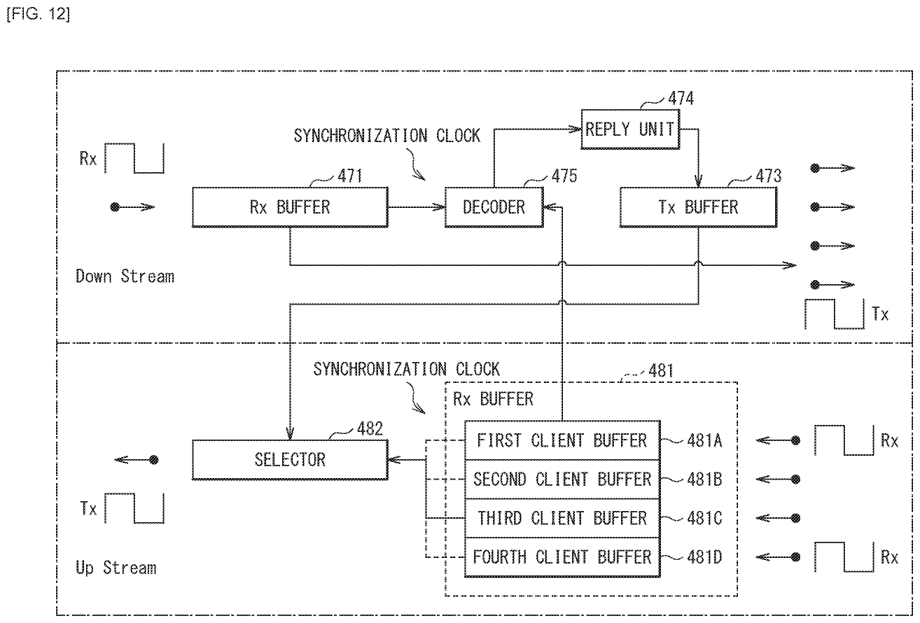

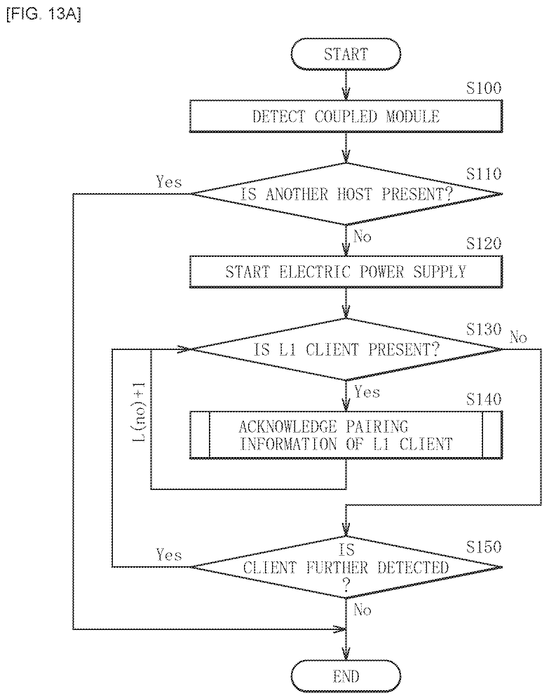

Next, referring to FIGS. 11 and 12, data transmission and reception performed by the client 4 will be described. FIG. 11 is an explanatory diagram illustrating data transmission performed by the client 4.

For example, a case is considered where data is transmitted from the host 3 of upstream L0 (layer 0) to the client 4 of L1 (layer 1), and data is transmitted from the client 4 of L1 (layer 1) to the client 4 of downstream L2.

In this case, as illustrated in FIG. 11, the client 4 of L1 receives data transmitted from the light emitting diode (LED, corresponding to the transmitter 131) of the host 3 of L0 by the photodiode (PD, corresponding to the receiver 132). Thereafter, the client 4 of L1 transmits a light emission signal to the photodiode (PD, corresponding to the receiver 132) of the client 4 of L2 from the light emitting diode (LED, the transmitter 131).

In the communication module 1 according to the present embodiment, the transmitter 131 and the receiver 132 performs data transmission and reception in synchronization with the switching of the polarity of the power source. For this reason, in the transmitter 131 and the receiver 132, data is transmitted and received once in each cycle of the switching of the polarity of the power source.

Accordingly, the module system 5 is able to transmit the data received from the host 3 of L0 to the client 4 of L2 after one cycle by coinciding a timing at which data is transmitted from upstream to downstream and a timing at which data is transmitted from downstream to upstream in each of the host 3 and the client 4. The module system 5 is thus able to transmit 1-bit or multiple-bit data to the clients 4 sequentially coupled thereto every cycle of the switching of the polarity of the power source. Accordingly, the module system 5 is able to reduce a delay of the signal transmission to one clock.

In addition, the module system 5 is able to transmit the data received by the receiver 132 on the upstream side to the next client 4 by the transmitter 131 on the downstream side within one cycle in which the polarity of the power source switches. Specifically, the receiver 132 on the upstream side and the receiver 132 on the downstream side of the client 4 are set to operate in the same power source polarity, and the transmitter 131 on the upstream side and the transmitter 131 on the downstream side of the client 4 are set to operate in the same power source polarity. This allows the client 4 to transmit data received from upstream to downstream in one cycle, which makes it possible for the module system 5 to further reduce the delay of the signal transmission to ½ clocks.

Next, referring to FIG. 12, handling of the received data inside the client 4 will be described. FIG. 12 is a block diagram illustrating a function regarding data transmission in the upstream direction or the downstream direction inside the client 4.

For example, as illustrated in FIG. 12, in the direction from upstream to downstream (Down Stream), data received by the receiver 132 on the upstream side is first stored in an Rx buffer 471 and decoded by a decoder 475. The client 4 determines a request command to be transmitted from the host 3 to the client 4 on the basis of the decoded data and executes the request command by the function unit 472 or the like.

In a case where a command that requires a response to the host 3 is included in the request command to be transmitted from the host 3 to the client 4, the reply unit 474 generates a response to the host 3. After being stored in a Tx buffer 473, the generated response is transferred to a selector 482 in the direction from downstream to upstream direction (Up Stream), and is transmitted from the transmitter 131 on the upstream side with priority order set by the selector 482.

Further, of data received by the receiver 132 on the upstream side, data to be transmitted to the downstream client 4 is distributed to each transmitters 131 on the downstream side and simultaneously transmitted from the transmitter 131 to the downstream client 4.

In the direction from downstream to upstream (Up Stream), data received by each of the receivers 132 provided on the plurality of connection surfaces 100 on the downstream side is stored in an Rx buffer 481. For example, in a case where four clients 4 are coupled to the downstream side of the client 4, the Rx buffer 481 stores respective pieces of data received from the clients 4 separately in a first client buffer 481A, a second client buffer 481B, a third client buffer 481C, and a fourth client buffer 481D.

The pieces of data stored in the Rx buffer 481 are prioritized by the selector 482 and transmitted from the transmitter 131 on the upstream side to the upstream host 3 or client 4. Further, the selector 482 sets the priority order between the response to the request command from the host 3 and the data transmitted from downstream to upstream.

In the direction from downstream to upstream (Up Stream), data is received from each of the receivers 132 provided on the plurality of connection surfaces 100, the pieces of data are individually stored in the Rx buffer 481 so as not to be crossed. Further, in the case where those pieces of data from the transmitter 131 on the upstream side to the upstream host 3 or client 4, the selector 482 sets the priority order to serialize and transmit the pieces of data, in order to avoid collision.

### 2.4. Operation Examples

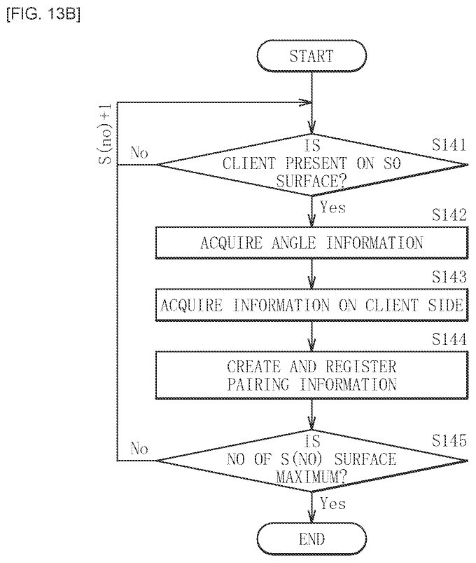

Referring to FIGS. 13A to 20, pairing operation between the host 3 and the client 4 in the module system 5 will be described below. In the module system 5, the host 3 performs pairing with the client 4, thereby being able to grasp order of connection, an orientation, and a rotation angle of the connection of the client 4 in the module system 5. This allows the host 3 to automatically grasp a structure of the module system 5. The pairing operation between the host 3 and the client 4 is executed when, for example, the host 3 and the client 4 are coupled to each other.

(Operation of Pairing Host with Client)

First, referring to FIGS. 13A and 13B, a flow of the pairing operation between the host 3 and the client 4 will be described. FIG. 13A is a flowchart illustrating a flow of operation of pairing the host 3 with the client 4.

As illustrated in FIG. 13A, first, the host 3 coupled to the client 4 detects the coupled communication module(s) 1 (client 4) (S100). At this time, the host 3 determines whether or not another host 3 is present in the coupled communication module(s) 1 (S110). In a case where it is determined that the other host 3 is present (S110/Yes), the host 3 terminates the pairing operation to avoid control and electric power collisions with the other host 3. Whether or not the host 3 is present in the coupled communication module(s) 1 may be determined, for example, by detecting a signal outputted from the host 3. In a case where it is determined that no other host 3 is present (S110/No), the host 3 starts supplying electric power simultaneously to the coupled client(s) 4 (S120).

Thereafter, the host 3 determines whether or not a client 4 of L1 (layer 1) coupled to the host 3 which is L0 (layer 0) is present (S130). In a case where it is determined that the client 4 of L1 is present (S130/Yes), the host 3 performs a process of acknowledging pairing information for each client 4 of L1 (S140). As will be described later referring to FIG. 13B, the process of acknowledging the pairing information is, for example, a process of acquiring information regarding a surface, an orientation, and an angle to which the client 4 is coupled, and registering the acquired information as the pairing information. Thereafter, the host 3 returns to S130 to determine whether or not the client 4 of L2 (layer 2) coupled to L1 is present. Thus, the host 3 increments the number of the layer by one, and executes the detection of the client 4 and the process of acknowledging the pairing information.

In a case where it is determined that no client 4 is present in S130 (S130/No), the host 3 performs again the detection of the client 4 and determines whether or not the client 4 is further detected for confirmation (S150). In a case where it is determined that the client 4 is detected (S150/Yes), the host 3 returns to S130 and executes the detection of the client 4 and the process of acknowledging the pairing information. In a case where it is determined that no client 4 is detected (S150/Yes), the host 3 terminates the pairing operation.

Next, referring to FIG. 13B, the process of acknowledging the pairing information will be described. FIG. 13B is a flowchart illustrating a flow of the process of acknowledging the pairing information.

As illustrated in FIG. 13B, first, the host 3 determines whether or not the client 4 is present on an S0 surface on the basis of numbers sequentially allocated from 0 to the connection surfaces 100 (S141). In a case where it is determined that no client 4 is present on the S0 surface, the host 3 increments the number allocated to the connection surface 100 by one, and thereafter returns to S141 to determine whether or not the client 4 is present on an S1 plane.

In a case where it is determined that the client 4 is present on the S0 surface, the host 3 acquires information regarding the rotation angle of the connection of the client 4 on the basis of a reception strength of a signal from the client 4 on the connection surface 100 (S142). Thereafter, the host 3 acquires information on a coupled client 4 side from the coupled client 4 (S143). The information on the client 4 side is, for example, information regarding the connection surface on the client 4 side, and the orientation and the angle of the client 4. Thereafter, the host 3 creates the pairing information of the client 4 using the acquired information and registers the pairing information in a database or the like (S144).

Thereafter, the host 3 increments the number allocated to the connection surface 100 by one, and creates the pairing information of the client 4. After completing the pairing information creation performed by the client 4 for the connection surface 100 of the maximum allocated number (S145/Yes), the host 3 terminates the process of acknowledging the pairing information. The host 3 is thus able to create and register the pairing information of the client 4 in every connection surface 100.

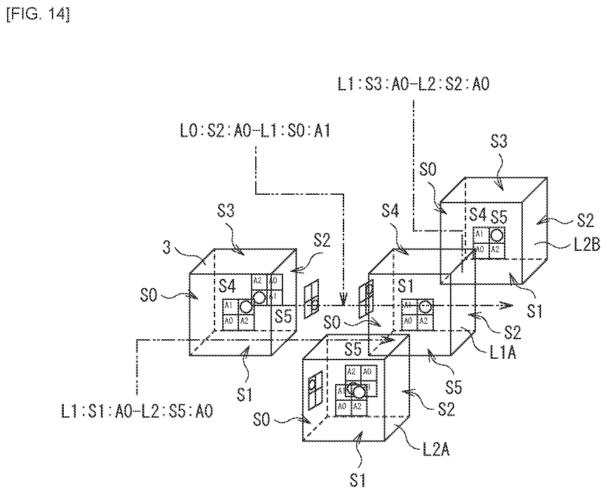

Referring now to FIG. 14, a specific example of the pairing information will be described. FIG. 14 is an explanatory diagram illustrating an example of connections between the host 3 and the clients 4 and an example of pairing information of each connection.

As illustrated in FIG. 14, for example, it is assumed that a client L1A of L1 (layer 1) is coupled to the host 3 of L0 (layer 0), and clients L2A and L2B of L2 (layer 2) is coupled to the client L1A of L1. It is assumed that the numbers S0, S1, S2, S3, S4, and S5 are set to the connection surfaces 100 of each of the host 3 and the clients L1A, L2A, and L2B. It is assumed that the client L1A is rotated by 90 degrees counterclockwise about a rotational axis that directs from the S0 surface to the S2 surface with respect to the host 3 and the clients L2A and L2B.

In such a case, it is possible to represent pairing information of each interconnection of the host 3 and the clients L1A, L2A, and L2B in a combination of layer information, connection surface information, and angle information. The layer information is information that indicates which hierarchy the host 3 or the client L1A, L2A, or L2B belongs in the module system 5 as a whole. The connection surface information is information indicating on which connection surface 100 the host 3 or the clients L1A, L2A, or L2B is coupled to another client. The angle information is information indicating a three-dimensional orientation of the host 3 or the client L1A, L2A, or L2B.

Specifically, pairing information of a connection between the host 3 and the client L1A may be represented by a combination of: layer information “L0”, connection surface information “S2”, and angle information “A0”, which are host 3 side pairing information; and layer information “L1”, connection surface information “S0”, and angle information “A1”, which are client L1A side pairing information. Further, pairing information of a connection between the clients L1A and the client L2A may be represented by a combination of: layer information “L1”, connection surface information “S1”, and angle information “A0”, which are client L1A side pairing information; and layer information “L2”, connection surface information “S5”, and angle information “A0”, which are client L2A side pairing information. Moreover, pairing information of a connection between the client L1A and the client L2B may be represented by a combination of: layer information “L1”, connection surface information “S3”, and angle information “A0”, which are client L1A side pairing information; and layer information “L2”, connection surface information “S2”, and angle information “A0”, which are client L2B side pairing information.

The pairing information may further include function information of each client 4. The function information is information indicating a function, a size, a movable range, or the like of the function unit 472 included in each client 4. According to this, the module system 5 is able to derive a shape of the module system 5 as a whole on the basis of the information regarding the interconnection of the clients 4 and the size of the function unit 472 included in the function information of each of the clients 4.

In such a case, the module system 5 is able to derive the shape as a whole, and is therefore able to set a movable range in such a manner that does not touch another client 4 for the function unit 472 such as a servo in which a movable range is settable. According to this, the module system 5 is able to avoid damage due to collision between the clients 4, or between the respective function units 472 provided in the client 4. In other words, the module system 5 is able to make appropriate a deformation or movable range of the module system 5 by grasping the shape as a whole.

According to the above flow, the pairing operation between the host 3 and the client 4 is performed. In the module system 5, the pairing with the host 3 makes it possible to define the upstream and downstream directions in the module system 5. Thus, the client 4 is able to dynamically switch communication path setting on the basis of the upstream and downstream directions.

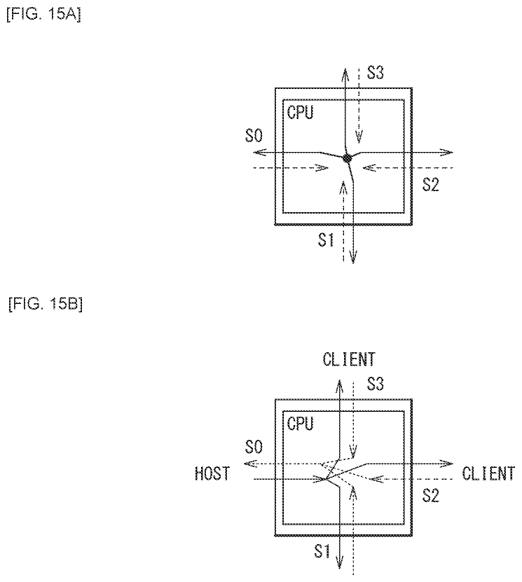

Referring to FIGS. 15A and 15B, a change in the communication path setting performed by the client 4 before and after the pairing operation will be described. FIG. 15A is a schematic view of communication path setting performed by the client 4 before the pairing. FIG. 15B is a schematic view of communication path setting performed by the client 4 after the pairing.

It is to be noted that, although FIGS. 15A and 15B each illustrate S0 to S3 as the respective connection surfaces 100, the number of connection surfaces 100 is not limited to the number of the connection surfaces 100 illustrated in FIGS. 15A and 15B. The number of connection surfaces 100 may be smaller or may be greater than the number of connection surfaces 100 illustrated in FIGS. 15A and 15B.

As illustrated in the FIG. 15A, prior to pairing, it is unknown to the client 4 on which connection surface 100 side the host 3 is present. Accordingly, the client 4 equally controls whether to perform transmission and reception with respect to any of the connection surfaces 100. Thus, in such a case, the client 4 individually determines whether or not communication is from the host 3 side for each of the communications, and controls the transmission and the reception.

In the module system 5 according to the present embodiment, upon starting electric power supply to the client 4, the host 3 transmits host 3 presence notifications to all the clients 4 coupled to the host 3 and performs the pairing operation with each of the clients 4. This allows the client 4 to determine the connection surface 100 on the side on which the host 3 is present, and is thus able to switch the communication path setting in such a manner that the communication with the host 3 and with the other client 4 may be performed more efficiently.

Specifically, as illustrated in FIG. 15B, the client 4 switches the communication path setting in such a manner that the client 4 distributes separately data received from the upstream side to which the host 3 is coupled to each of the clients 4 on the downstream side, and aggregates the data received from each of the clients 4 on the downstream side and transmits the aggregated data to the host 3 or the client 4 on the upstream side. For example, in the example illustrated in FIG. 15B, the host 3 is coupled to the S0 surface side of the client 4. Accordingly, the client 4 switches the communication path setting in such a manner that the client 4 distributes separately data received by the S0 surface to the S1 surface, the S2 surface, and the S3 surface, and aggregates the data received on each of the S1 surface, the S2 surface, and the S3 surface and transmits the aggregated data to the S0 surface.

According to this, the module system 5 performs the pairing operation to thereby set the communication path setting of each of the clients 4 as a structure in which the clients 4 are coupled in a tree shape with the host 3 being provided as a top point. Thus, the module system 5 is able to improve efficiency of the communication between the host 3 and the client 4.

(Address Assignment Operation from Host to Client)

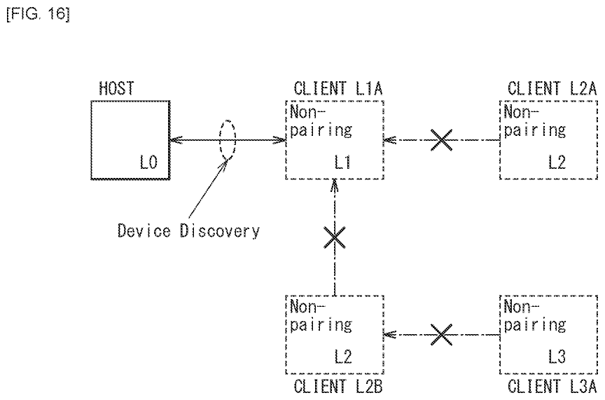

Next, a flow of operation of the host 3 assigning an address to each of the clients 4 will be described with reference to FIGS. 16 to 19. The module system 5 allows the host 3 to control the client 4 more efficiently by assigning a unique address to each of the clients 4 coupled to the host 3.

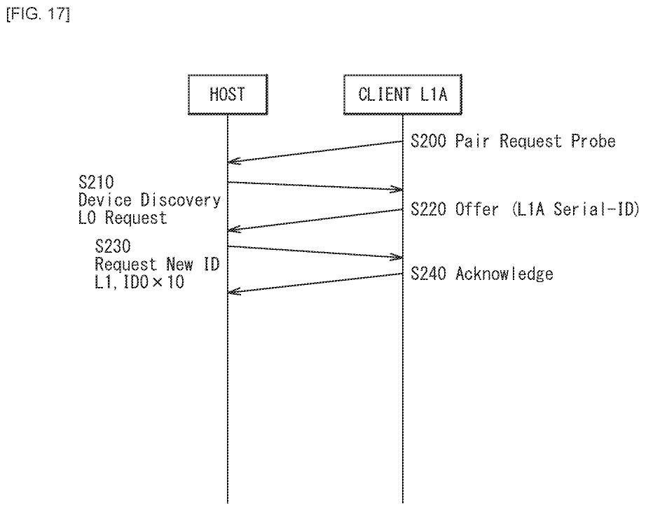

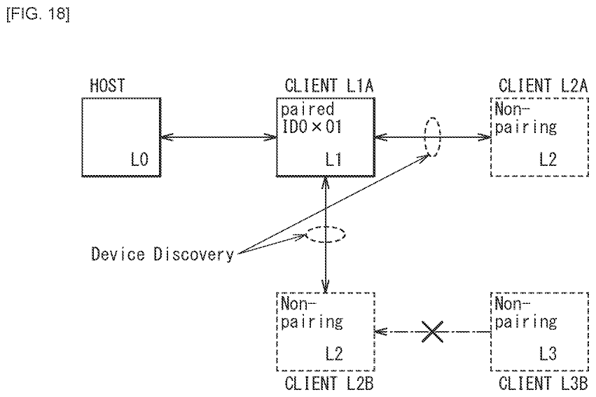

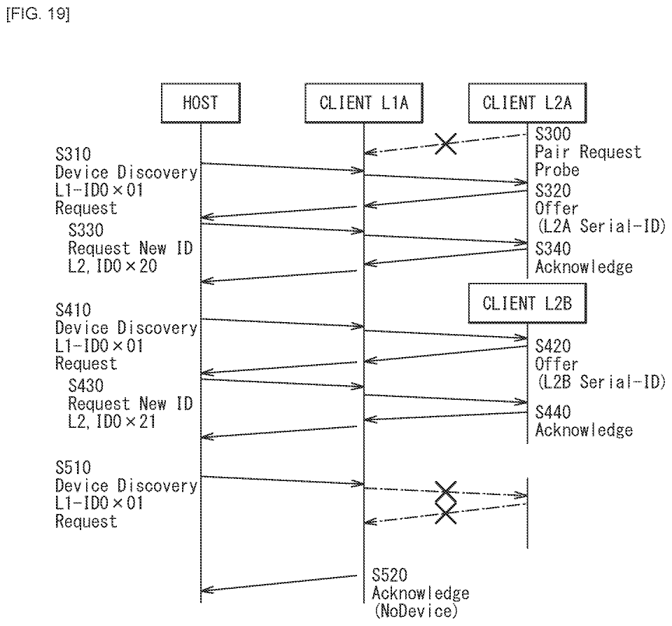

FIG. 16 is a schematic view of a mode of a connection between the host 3 and the client 4 of L1 when the host 3 of L0 (layer 0) assigns an address to the client 4 of L1 (layer 1). FIG. 17 is a sequence diagram illustrating a flow of operation of the host 3 assigning an address to the client 4 of L1. FIG. 18 is a schematic view of a mode of a connection between the host 3 and the client 4 when the host 3 assigns an address to the client 4 of L2 (layer 2). FIG. 19 is a sequence diagram illustrating a flow of operation of the host 3 assigning an address to the client 4 of L2.

As illustrated in FIG. 16, for example, in a case where four clients L1A, L2A, L2B, and L3A are coupled to the host 3, first, electric power is simultaneously supplied from the host 3 to all four clients L1A, L2A, L2B, and L3A. At this time, each of the clients L1A, L2A, L2B, and L3A is in the communication path setting prior to the pairing illustrated in FIG. 15A. This allows the host 3 to be communicable only with the directly coupled client L1A, and is in a state of being unable to communicate with the clients L2A, L2B, and L3A in subsequent stages.

Here, as illustrated in FIG. 17, first, the client L1A transmits Pair Request Probe serving as a pairing request to the host 3 (S200). Thereafter, the host 3 that has received Pair Request Probe transmits a Device Discovery packet to the client L1A (S210).

The client L1A that has received the Device Discovery packet sends Serial ID by which the client L1A is individually identifiable to the host 3 (S220). This causes the host 3 to transmit a layer ID (ID0x10) associated with the sent Serial ID to the client L1A (S230). The client L1A that has received the layer ID sends back reception acknowledgement (Ack) (S240), thereby completing the pairing with and the address assignment to the client L1A.

As illustrated in FIG. 18, completion of the pairing between the host 3 and the client L1A and the address assignment allows the communication path setting of the client L1A to be switched to a state as illustrated in FIG. 15B, and the host 3 becomes communicable with the clients L2A and L2B.

Here, Pair Request Probe transmitted from the client L2A upon the electric power supply does not reach the host 3. Accordingly, the host 3 searches for a lower client subsequently to the pairing with and the address assignment to the client L1A. Specifically, as illustrated in FIG. 19, the host 3 transmits a Device Discovery packet to the client L1A (S310). The client L1A further transmits the Device Discovery packet that has been transmitted from the host 3 to the client L2A.

The client L2A that has received the Device Discovery packet sends, in a similar manner as the client L1A, Serial ID by which the client L2A is individually identifiable to the host 3 (S320). This causes the host 3 to transmit a layer ID (ID0x20) associated with the sent Serial ID to the client L2A (S330). The client L2A that has received the layer ID sends back reception acknowledgement (Ack) (S340), thereby completing the pairing with and the address assignment to the client L2A.

Thereafter, the host 3 further transmits a Device Discovery packet to the client L1A subsequently to the pairing with and the address assignment to the client L2A (S410). The client L1A transmits the Device Discovery packet that has been transmitted from the host 3 to the client L2B.

The client L2B that has received the Device Discovery packet sends, in a similar manner as the client L2A, Serial ID by which the client L2B is individually identifiable to the host 3 (S420). This causes the host 3 to transmit a layer ID (ID0x21) associated with the sent Serial ID to the client L2B (S430). The client L2B that has received the layer ID sends back reception acknowledgement (Ack) (S440), thereby completing the pairing with and the address assignment to the client L2B.

In addition, the host 3 further transmits a Device Discovery packet to the client L1A subsequently to the pairing with and the address assignment to the client L2B (S510). The client L1A transmits the Device Discovery packet that has been transmitted from the host 3 to the connection surface 100 other than the connection surfaces 100 to which the clients L2A and L2B are coupled, but there is no response to the Device Discovery packet. Thus, the client L1A transmits a notification to the host 3 that the pairing and the address assignment have been completed (S520). With the above operation, the host 3 is able to perform the pairing with and the address assignment to the clients L1A, L2A, and L2B in L1 and L2.

Thereafter, the host 3 transmits a Device Discovery packet to each of the clients L2A and L2B in a similar manner as the Device Discovery packet transmission to the client L1A, thereby being able to perform pairing with and address assignment to each of the clients 4 coupled to L3 (layer 3).

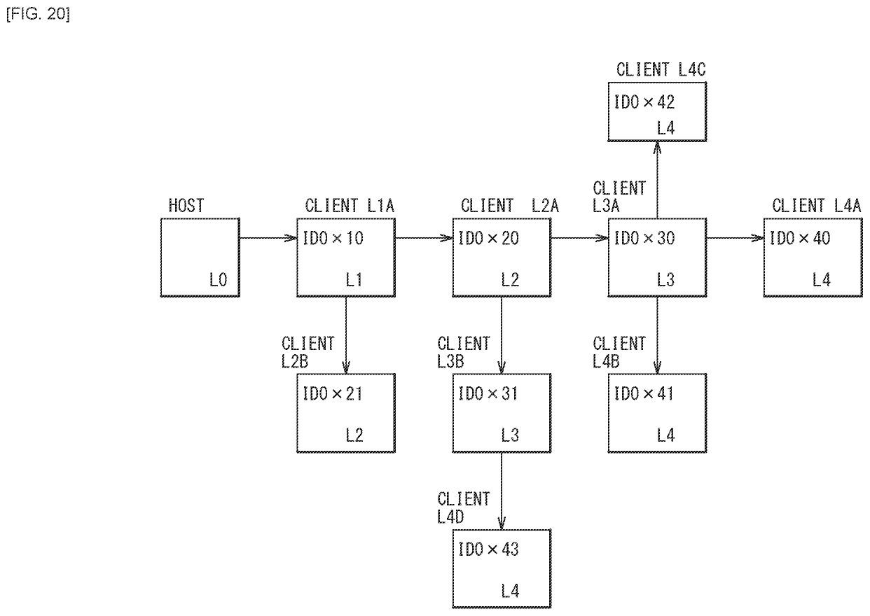

With the above operation, in the module system 5, the host 3 is able to assign an address to each of the clients 4 coupled thereto. FIG. 20 illustrates examples of addresses assigned to the respective clients 4. FIG. 20 is a block diagram illustrating an example of a connection structure of the host 3 and the clients 4, and examples of addresses in the connection structure.

In the module system 5 illustrated in FIG. 20, the client L1A of L1 (layer 1) is coupled to the host 3 of L0 (layer 0), and the clients L2A and L2B of L2 (layer 2) are coupled to the client L1A of L1. Further, clients L3A and L3B of L3 (layer 3) are coupled to the client L2A of L2. Moreover, clients L4A, L4B, and L4C of L4 (layer 4) are coupled to the client L3A of L3, and a client L4D of L4 is coupled to the client L3B of L3.

In such a case, for example, the host 3 is able to assign an address “ID0x10” to the client L1A of L1, an address “ID0x20” to the client L2A of L2, and an address “ID0x21” to the client L2B of L2. Further, the host 3 is able to assign an address “ID0x30” to the client L3A of L3 and an address “ID0x31” to the client L3B of L3. Moreover, the host 3 is able to assign an address “ID0x40” to the client L4A of L4, an address “ID0x41” to the client L4B of L4, an address “ID0x42” to the client L4C of L4, and an address “ID0x43” to the client L4D of L4.

### 3. Additional Remarks

Although the disclosure is described hereinabove with reference to the example embodiments and modification examples, these embodiments and modification examples are not to be construed as limiting the scope of the disclosure and may be modified in a wide variety of ways.

For example, in the module system 5, it is possible to freely detach the coupled client. Whether or not the coupled client 4 maintains the connection may be determined, for example, by each client 4 acknowledging a response from the client 4 of the lower layer. Specifically, in a case where each client 4 receives no response from the client 4 of the lower layer, the each client 4 may notify the host 3 that the corresponding client 4 has been detached. Thus, the host 3 that has received the notification is able to delete the pairing information of the detached client 4 from the registered pairing information.

Further, the module system 5 is able to grasp the tree-shaped connection structure of the host 3 and the clients 4, thereby being able to detect a loop that occurs in the connection between the host 3 and the clients 4. In such a case, it is possible for the module system 5 to prompt a user to resolve the loop by indicating to the user a position of the loop or by indicating a connection example that resolves the loop. In a case where it is possible to acknowledge that no loop is present, no electric power collision occurs. Thus, the module system 5 is able to supply electric power from a plurality of power sources.

Moreover, the module system 5 is able to show to the user a connection of the client 4 in which no loop occurs, a more efficient connection of the client 4, or the like, by learning the connection of the client 4 to the host 3. Further, the module system 5 is also able to automatically make appropriate the entire structure and the movable range by learning the connection of the client 4 to the host 3.

In addition, each of the host 3 or the clients 4 of the module system 5 may enhance interactivity to the user. Specifically, when another client 4 is coupled thereto, each of the host 3 or the client 4 may output sound or light that notifies the user that the connection (the pairing) has been established. Further, each of the host 3 or the clients 4 may detect that it has been lifted by the user with an acceleration sensor, and may take an action such as outputting sound or light. To enable these actions, the client 4 may also be equipped with a power source such as a battery.

Such a module system 5 is applicable to, for example: a battle robot; or a household robot such as a toy robot that is able to perform various kinds of operation. Further, the module system 5 is also applicable to, for example: an industrial robot such as a pick-up arm robot for manufacturing or logistics, which is adaptable to dynamical recombination of lines; or an IoT (Internet of Things) device, to which a sensor module is optionally addable.

In addition, not all of the configuration and the operation described in the above embodiments are indispensable as the configuration and the operation of the present disclosure. For example, among the components in the above-described embodiments, components not described in the independent claims indicating the most significant concepts of the present disclosure are to be understood as optional components.

The terms used throughout this specification and the appended claims should be construed as “non-limiting” terms. For example, the term “comprising” or “being comprised” should be construed as “not being limited to the mode recited as being comprised”. The term “including” should be construed as “not being limited to the mode recited as being included”.

The terms used herein are used merely for convenience of explanation and include terms that are not used to limit the configuration and operation. For example, the terms “right”, “left”, “top”, “bottom”, and the like only indicate a direction on the drawing being referred to. The terms “inner side” and “outer side” merely indicate a direction toward the center of an element of interest and a direction away from the center of the element of interest, respectively. The same applies to terms similar to these terms and terms having similar meaning.

It is to be noted that the technology according to the present disclosure may have the following configurations. According to the technology of the present disclosure having the following configurations, even in a case where a communication module is rotated and coupled to a connection surface of another communication module, it is possible to perform data transmission and reception and to perform electric power supply. The communication modules are thus able to be coupled to each other at a higher degree of freedom. Effects according to the technology of the disclosure are not necessarily limited to those described herein. The present disclosure may further include any effects other than those described herein.

(1)

A communication module including:

a transmitter and a receiver each disposed at an approximate center of a connection surface, the transmitter transmitting and the receiver receiving data by a data communication scheme with which the transmitter and the receiver are compatible; and

a first electrode and a plurality of second electrodes, the first electrode having a polarity that is different from a polarity of the plurality of second electrodes, the first electrode and the plurality of second electrodes being disposed in an arrangement that is N-fold symmetric (where N is a natural number of 3 or more) in an outer periphery of the transmitter and the receiver, the transmitter and the receiver being disposed on the connection surface.

(2)

The communication module according to (1), in which a polarity of the first electrode and a polarity of the plurality of second electrodes are switched alternately at a predetermined cycle.

(3)

The communication module according to (2), in which the transmitter transmits and the receiver receives the data alternately at a cycle synchronized with a cycle of polarity switching of the first electrode and the plurality of second electrodes.

(4)

The communication module according to (3), in which the transmitter transmits and the receiver receives one bit of the data in one cycle of transmission and reception.

(5)

The communication module according to any one of (1) to (4), in which the transmitter transmits and the receiver receives the data by wireless communication.

(6)

The communication module according to (5), in which the transmitter transmits and the receiver receives the data by a wireless communication scheme using visible light, infrared light, or a magnetic field.

(7)

The communication module according to any one of (1) to (6), in which a plurality of the receivers is disposed on the connection surface, and respective reception sensitivities of the plurality of receivers are variable.

(8)

The communication module according to (7), in which the transmitter and the plurality of receivers are disposed on a single circumference.

(9)

The communication module according to any one of (1) to (8), in which a shape of the first electrode engages with a shape of each of the plurality of second electrodes.

(10)

The communication module according to any one of (1) to (9), in which

the first electrode and the plurality of second electrodes each include a fixation mechanism, and

the fixation mechanism physically couples the first electrode and the plurality of second electrodes with each other.

(11)

The communication module according to any one of (1) to (10), in which the communication module operates as a host to which one or more clients are coupled.

(12)

The communication module according to (11), in which the first electrode and the plurality of second electrodes supply electric power simultaneously to each of the clients.

(13)

The communication module according to (11) or (12), in which the transmitter transmits a discovery packet sequentially to each of the clients.

(14)

The communication module according to (13), in which the transmitter transmits address information to each of the clients which has responded to the discovery packet, the address information identifying the client.

(15)

The communication module according to any one of (1) to (10), in which the communication module operates as a client to be coupled to a host.

(16)

The communication module according to (15), in which the transmitter and the receiver switch a path through which the data is to be transmitted and received on a basis of a direction in which a signal transmitted from the host is received.

(17)

The communication module according to (16), in which the path has a tree structure.

(18)

The communication module according to any one of (1) to (17), in which a shape of the communication module is a polyhedron.

(19)

The communication module according to (18), in which

a plurality of the connection surfaces is disposed on the polyhedron, and

the transmitter, the receiver, the first electrode, and the plurality of second electrodes are disposed on each of the plurality of connection surfaces.

(20)

A communication method including:

supplying electric power by a first electrode and a plurality of second electrodes each disposed on a connection surface in an arrangement that is N-fold symmetric (where N is a natural number of 3 or more), the first electrode having a polarity that is different from a polarity of the plurality of second electrodes; and

transmitting and receiving data by a transmitter and a receiver each disposed at an approximate center of the connection surface at an inner side than the first electrode and the plurality of second electrodes, by a data communication scheme with which the transmitter and the receiver are compatible.

This application claims the benefit of Japanese Priority Patent Application JP2020-026293 filed with the Japan Patent Office on Feb. 19, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A communication module comprising:
a transmitter and a receiver each disposed at an approximate center of a connection surface, the transmitter transmitting and the receiver receiving data by a data communication scheme with which the transmitter and the receiver are compatible; and
a first electrode and a plurality of second electrodes, the first electrode having a polarity that is different from a polarity of the plurality of second electrodes, the first electrode and the plurality of second electrodes being disposed in an arrangement that is N-fold symmetric (where N is a natural number of 3 or more) in an outer periphery of the transmitter and the receiver, the transmitter and the receiver being disposed on the connection surface.

2. The communication module according to claim 1, wherein a polarity of the first electrode and a polarity of the plurality of second electrodes are switched alternately at a predetermined cycle.

3. The communication module according to claim 2, wherein the transmitter transmits and the receiver receives the data alternately at a cycle synchronized with a cycle of polarity switching of the first electrode and the plurality of second electrodes.

4. The communication module according to claim 3, wherein the transmitter transmits and the receiver receives one bit of the data in one cycle of transmission and reception.

5. The communication module according to claim 1, wherein the transmitter transmits and the receiver receives the data by wireless communication.

6. The communication module according to claim 5, wherein the transmitter transmits and the receiver receives the data by a wireless communication scheme using visible light, infrared light, or a magnetic field.

7. The communication module according to claim 1, wherein
a plurality of the receivers is disposed on the connection surface, and
respective reception sensitivities of the plurality of receivers are variable.

8. The communication module according to claim 7, wherein the transmitter and the plurality of receivers are disposed on a single circumference.

9. The communication module according to claim 1, wherein a shape of the first electrode engages with a shape of each of the plurality of second electrodes.

10. The communication module according to claim 1, wherein
the first electrode and the plurality of second electrodes each include a fixation mechanism, and
the fixation mechanism physically couples the first electrode and the plurality of second electrodes with each other.

11. The communication module according to claim 1, wherein the communication module operates as a host to which one or more clients are coupled.

12. The communication module according to claim 11, wherein the first electrode and the plurality of second electrodes supply electric power simultaneously to each of the clients.

13. The communication module according to claim 11, wherein the transmitter transmits a discovery packet sequentially to each of the clients.

14. The communication module according to claim 13, wherein the transmitter transmits address information to each of the clients which has responded to the discovery packet, the address information identifying the client.

15. The communication module according to claim 1, wherein the communication module operates as a client to be coupled to a host.

16. The communication module according to claim 15, wherein the transmitter and the receiver switch a path through which the data is to be transmitted and received on a basis of a direction in which a signal transmitted from the host is received.

17. The communication module according to claim 16, wherein the path has a tree structure.

18. The communication module according to claim 1, wherein a shape of the communication module is a polyhedron.

19. The communication module according to claim 18, wherein
a plurality of the connection surfaces is disposed on the polyhedron, and
the transmitter, the receiver, the first electrode, and the plurality of second electrodes are disposed on each of the plurality of connection surfaces.

20. A communication method comprising:
supplying electric power by a first electrode and a plurality of second electrodes each disposed on a connection surface in an arrangement that is N-fold symmetric (where N is a natural number of 3 or more), the first electrode having a polarity that is different from a polarity of the plurality of second electrodes; and
transmitting and receiving data by a transmitter and a receiver each disposed at an approximate center of the connection surface at an inner side than the first electrode and the plurality of second electrodes, by a data communication scheme with which the transmitter and the receiver are compatible.
